(19) United States
(12) Patent Application Publication
(10) Pub. No.: US 2008/0260326 A1
(43) Pub. Date: Oct. 23, 2008

(54) Optical Coupling Device

(76) Inventors: Gnitabourne Yabre, Mainvilliers (FR); Bogdan Rosinski, Brest (FR); Yves Stricot, Villepreux (FR)

Correspondence Address: HARRINGTON & SMITH, PC, 4 RESEARCH DRIVE, SHELTON, CT, 06484-6212, US

(21) Appl. No.: 11/628,173

(22) PCT Filed: Jun. 7, 2005
(86) PCT No.: PCT/EP05/06098

§ 371 Date: Jan. 14, 2008

(30) Foreign Application Priority Data
Jun. 7, 2004 (FR) 0451121

(51) Int. Cl. G02B 6/12

(52) U.S. Cl. 385/14

(57) ABSTRACT

The object of the invention is an optical coupling device between at least one waveguide embedded in a printed circuit, for conveying an optical beam (F), and an external waveguide, the circuit including, starting from an exterior surface of the circuit, at least one insulating first layer and at least one internal layer incorporating at least one core of embedded waveguide forming said optical path, the device including a coupling element, positioned in a cut, hollowed out in the circuit and cutting the embedded waveguide, the coupling element being furnished with means of refocusing of the optical beam between the embedded waveguide and the external waveguide and at least one lower positioning surface on a reference surface of the cut in relation to the axis of the embedded waveguide.

The present invention relates to an optical coupling device, particularly one between a planar circuit, such as a printed circuit provided with embedded waveguide layers, and at least one external waveguide.

The creation of high-speed optoelectronic systems uses optical couplers to transmit optical signals between cards referred to as optical backplane cards and intercard optical fibers or daughter cards.

The backplane cards, like the daughter cards, can combine optical paths and electrical paths. The connection of the electrical paths uses electrical connectors and the connection of the optical paths uses optical couplers.

One problem of optical coupling is that it is necessary to have the optical signal exit the waveguide in the backplane and, in order to do this, the waveguide is interrupted and the direction of the optical beam is changed.

A solution that makes it possible to create a backplane provided with optical paths is described in the document WO 02/061481. This document concerns an embodiment for which layers of printed circuit and optical fibers terminated by a coupling element at 90° relative to the optical fibers are assembled in order to create a subassembly that constitutes a backplane.

This principle of embodiment is complex and necessitates several steps, including the grouping of the fibers, the encapsulation of the ends of these fibers in the coupling element, the positioning of the fibers on a first printed circuit, and the drilling of holes to maintain the coupling element on this first printed circuit and then the assembling of complementary printed circuit elements above and around the optical fibers, these complementary circuits having to be cut out so as to surround the coupling element.

Afterwards, a new cutting and drilling operation must be carried out in order to permit access to the coupling ends of the coupling elements, the operation concluding with the positioning of receiving supports for complementary optical connection plugs on the coupling elements. Such an embodiment is long, is difficult to produce, and, in particular, makes delicate the correct alignment of the optical plugs with the embedded coupling elements.

Moreover, this principle does not permit either considering the embedded fibers as tracks of the printed circuit during its design or creating a tapping of optical signals toward the outside from a waveguide extending on both sides of the coupling element.

An object of the present invention is to propose an optical coupling device that permits, during the design of the circuit forming the backplane, treating the optical paths in the same manner as the electrical paths and to treat the points of optical coupling toward the outside in the same way as the points of electrical connection. Furthermore, it permits a simplification of the circuit manufacturing steps while assuring a precise alignment between the optical cables and/or external waveguides being connected and the optical outlet zone of optical paths created by the waveguides embedded in the circuit.

In particular, it permits a simple embodiment of a link between a backplane card and one or more external daughter cards.

These aims are at least partially met, according to the invention thanks to an optical coupling device according to claim 1. The invention thus produces a compact optical coupling device that is positioned directly at the level of the embedded waveguide and that permits refocusing in a precise manner the optical beam between the embedded waveguide and the external waveguide by means of a simple cutting operation on the printed circuit and the insertion of the coupling element into this cut.

More particularly, the cut comprises a first section of a first width at the level of the insulating layer up to a reference surface and a second section at the level of the internal layer incorporating the embedded waveguide, the second section being of reduced width in relation to the first section in such a manner as to produce the reference surface as a substratum of the external plane, the coupling element comprising an upper body provided with lower positioning surfaces supported on the reference surface and a lower body arranged in the second section opposite to segments of the waveguide situated on one side or the other side of the cut.

In a particularly advantageous manner, said reference surface is the external surface of the core of the waveguide.

Other characteristics and advantages of the invention will be better understood by reading the description that follows of non-limiting embodiment examples of the invention with reference to the figures, which depict the following:

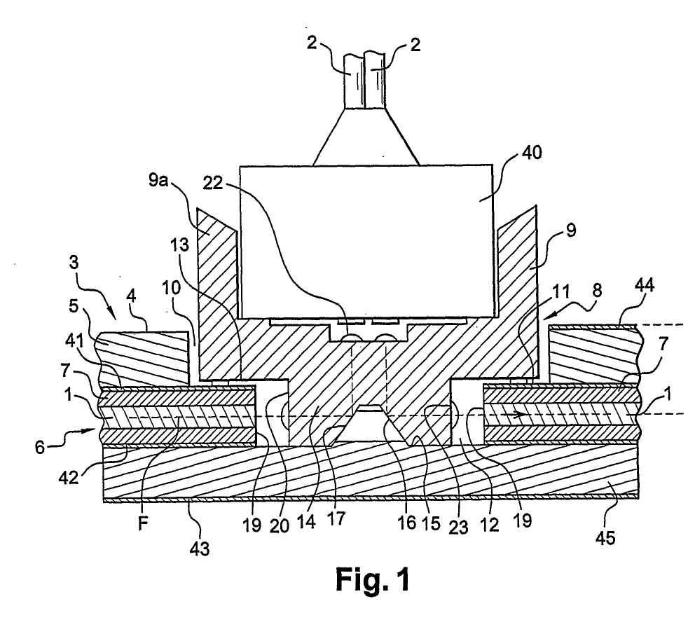

In FIG. 1, a schematic sectional view of a device according to a first embodiment of the invention;

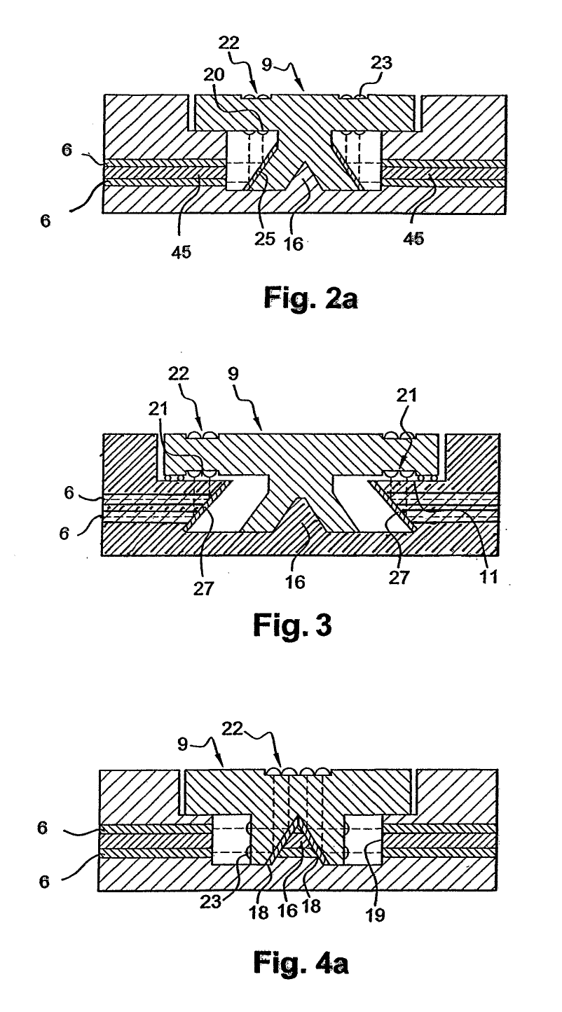

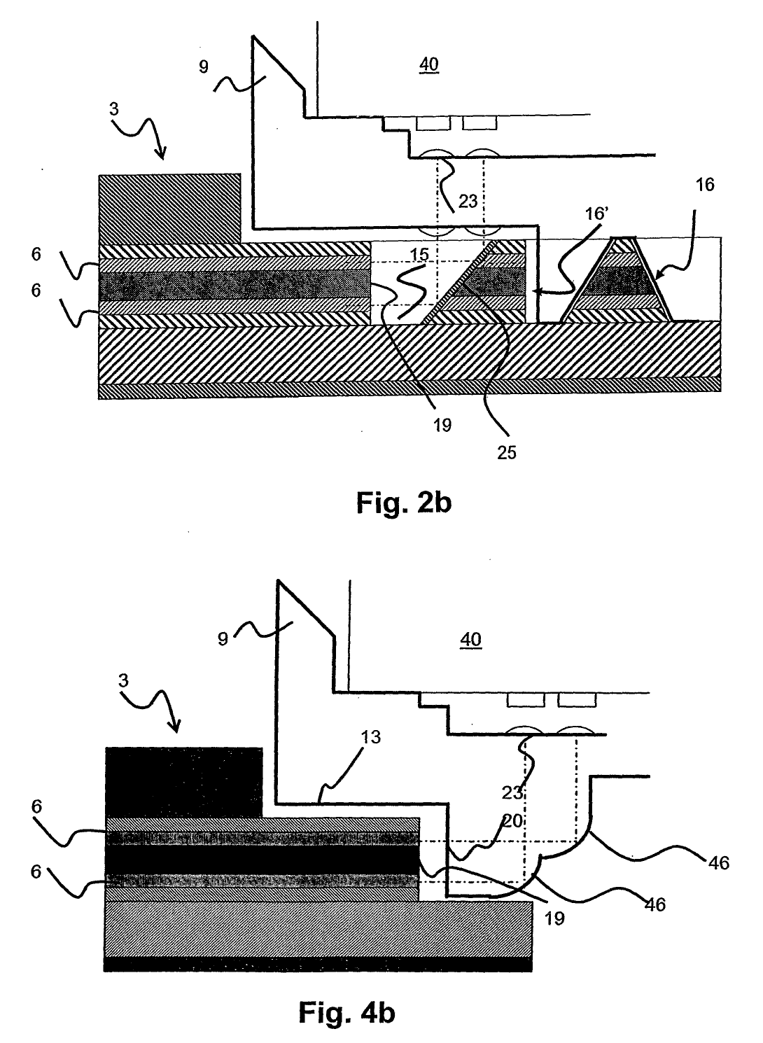

In FIG. 2a, a schematic sectional view of a device according to a second embodiment of the invention;

In FIG. 2b, a schematic sectional view of a device according to a third embodiment of the invention;

In FIG. 3, a schematic sectional view of a device according to a fourth embodiment of the invention;

In FIG. 4a, a schematic sectional view of a device according to a fifth embodiment of the invention;

In FIG. 4b, a schematic sectional view of a device according to a sixth embodiment of the invention;

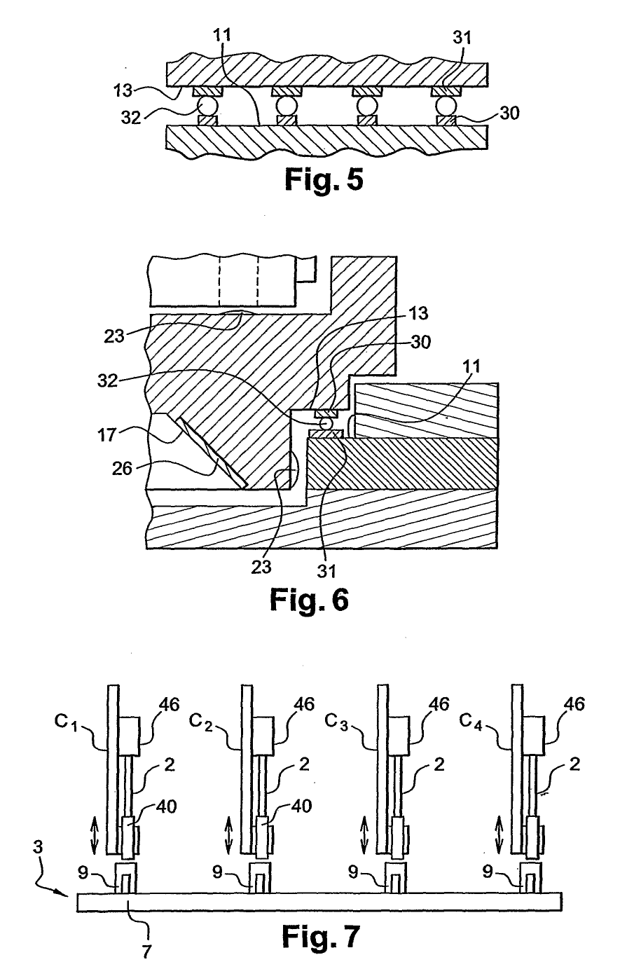

In FIG. 5, an embodiment detail of an embodiment of the invention for which the coupling device is centered by solder beads;

In FIG. 6, an enlarged view of an embodiment detail of the device of FIG. 1;

In FIG. 7, an example of use of the device according to the invention for the creation of optical links between a backplane card and daughter cards.

The invention relates to a coupling device that permits, in particular, the joining of optical paths in the form of external waveguides fixed on a card of the printed circuit type to optical paths embedded in another card of the printed circuit type.

The device represented in FIG. 1 is an embodiment example of the invention according to which the coupling device comprises a coupling element 9, in this case an optical coupler base receiving an optical plug 40 provided with two optical fibers 2 that form external waveguides. According to this example, two optical paths are connected in order to create an optical junction.

The printed circuit 3, depicted in the example, is a multilayer circuit comprising a first insulating layer 5 (in this case, the upper layer), electrical connection tracks 41, 42, 43, 44, at least one optical waveguide (or an optical path), and a lower insulating layer 45. The optical path or an embedded optical waveguide 6 comprises a core 1 surrounded by a cladding 7. The circuit may be well understood, in the framework of the invention, to comprise supplementary optical paths 6 superimposed on top of one another and on both sides of the coupling element.

In order to produce the optical coupling device, a cut is made in the circuit in order to reach the embedded waveguide 6 and to cut it into two segments 19.

The cut according to the invention is produced in such a manner that a reference surface 11 is created, this reference surface, positioned as a substratum of the upper surface defining the external plane of the circuit. The reference surface is positioned precisely in relation to the depth of the embedded waveguide 6 in the printed circuit and, more particularly, precisely in relation to the axis of the waveguide itself.

The cut and particularly the reference surface may be produced by an operation of chemical attack or of laser cutting of the circuit and/or of the optical cladding 7 of the waveguide 6 in such a way that the reference surface 11 is directly the external surface of the core 1 of the waveguide, the polymeric cladding of the waveguide then being dissolved by chemical attack.

In a simplified version, the reference surface is the external surface of the polymeric cladding 7 of the waveguide 6.

In order to simplify the production of the coupling element, the cut 8 comprises a first section 10 of a first width and a second section 12 of a width that is less than that of the first section, this creating two shoulders that constitute reference surfaces 11 on the sides of the cut.

The coupling element 9 itself is provided with an upper body 9a, consisting of wings under which are created lower positioning surfaces 13 that are supported on the reference surfaces 11, on both sides of the cavity produced by the cut 8 hollowed out in the circuit 3 and cutting the embedded waveguide 6.

For the optical coupling function, the coupling element 9 is provided with a lower body arranged in the second section opposite to the inlet/outlet faces of segments 19 of the embedded waveguide 6.

According to this configuration, the invention permits a precise alignment in height of the outlet of the ends of the segments 19 of the embedded waveguide 6 with the coupling element 9.

In order to increase the precision of the position of the coupling element 9 in relation to the segments 19 of the embedded waveguide 6, complementary centering profiles are provided between the coupling element 9 and the cut 8.

According to the example of FIG. 2a, the centering of the coupling element in its cavity is produced by a centering pad, made up of a centering profile 16 that projects from the base 15 of the cut 8 and is received in a complementary centering profile 17 in a recess at the lower end of the lower body of the coupling element 9.

According to this example, the centering profile 16 borne by the base 15 is a male profile provided with a generally conical form and, more particularly, in the form of a quadrilateral pyramid that orients the coupling element so as to align it with the segments 19 of the embedded waveguide 6, the coupling element 9 being provided with a centering profile in recess 17 in accordance with a pyramid in a corresponding recess.

A truncated cone form or any centering form may also be envisioned.

In order to produce the coupling, the beam F has to exit from the plane of the embedded waveguide 6 and be directed toward the exterior of the circuit and toward the optical fiber 2 or corresponding external waveguide.

In order to do this, a reflection of the beam via a reflecting surface must be carried out so as to direct it toward the optical fiber, in the case of an exiting beam, or else, from the optical fiber toward the embedded waveguide 6 in the case of an entering beam.

According to the example depicted, the optical axes of the optical fibers 2 are at 90° to the embedded waveguides and it is necessary to position a reflecting surface at 45° to the trajectory of the beam in order to produce a reflection at 90° in the most common case where the fibers are perpendicular to the circuit.

Several embodiments are proposed in the examples and particularly in the example of FIG. 1, which is enlarged in FIG. 6; the coupling element 9 is created by a material that is transparent to light at the wavelengths being transmitted. In order to direct the beam, the inclined face 26 of the centering profile 16 is metallized and constitutes a reflecting mirror that permits the reflection of the beam at 90°.

According to the example of FIG. 4a, in order to effect the reflection, the coupling element 9 comprises inclined reflecting faces 18 opposite to the centering profile 16, on one face of the coupling element 9 opposed to the face that is opposite the outlet 19 of the waveguide, said face 18 forming a reflecting face of the optical beam (F).

For these two variants, the optical pathway exits the embedded waveguides 6 in order to reenter in the foot of the coupling element and then re-exit the coupling element once again by its upper face.

In the variants of FIGS. 2a, 2b, and 3, the optical pathway passes through the wings of the upper body 9a of the coupling element.

According to the example of FIG. 2a, the external faces of the foot or lower body 14 are inclined reflecting faces 25 covered with a mirror coating so as to assure a good reflection of the optical beams issuing from the optical paths 6 toward the wings of the upper body 9a or vice versa.

FIG. 2b shows another embodiment of the reflection mode of the optical beam that uses a supplementary profile 16′ comprising an inclined reflecting surface 25. This surface 25 is arranged opposite to the inlet/outlet face of waveguides 6 with an inclination of 45° in relation to the bottom 15 of the cut. There, too, in order to assure a good reflection of the optical beams, the reflecting surface 25 is furnished with a metallic deposit.

According to the example of FIG. 3, a reflecting surface is produced by a beveled cut—for example, by laser ablation—of segments 19 of embedded waveguides 6. The beam reflected by the beveled face exits via the reference surfaces 11—for example, at 90° in relation to the axis of the embedded waveguide 6—so as to enter into the wings of the upper body 9a. In order to maintain a good reflection of the optical beam, even should particles become fixed on it, the reflecting facet 27 is metallized in addition.

In all of these configurations, the coupling element is provided with a first inlet/outlet face 20, 21 and with a second inlet/outlet face 22 of the beam F exiting from the upper plane of the circuit, the beam transiting in the coupling element between the first and second faces 20, 21, 22.

In order to optimize the coupling, the coupling element 9 described in the preceding examples may comprise coupling lenses 23 on its inlet/outlet faces 20, 21, 22, which permit significantly modifying the propagation of the light beam between the heterogeneous milieus constituted by the embedded waveguide, the interstice existing between the waveguide, and the coupling element itself. In a particularly advantageous manner, the coupling lenses 23 can permit reducing the divergence of the light beam or even refocusing it. The geometry of the lenses is determined as a function of the shaping desired for the light beam so as to optimize the coupling performance. The lenses may thus be diffractive or refractive and of any form whatsoever (for example, spherical or aspherical).

These lenses and the coupling element composing them may be produced directly by micromolding.

According to another embodiment of the coupling element, which no longer necessitates the use of lenses opposite to the inlet/outlet face of the segment 19 of the embedded waveguide 6, the employment of a curved facet is implemented in order to reflect the incident light beam. In order to produce a reflection of 90° of the light beam in the case where the optical fibers are arranged perpendicular to the waveguides, the curved facet displays a reflecting surface for which the angle of incidence and the angle of reflection are approximately 45°. FIG. 4b is a sectional view of an embodiment in which a coupling element 9 comprises a lower body that presents an inlet/outlet face 20 and a curved reflecting surface 46 opposite to this face. In this variant, a light beam exiting from the embedded waveguide 6 traverses the inlet/outlet face 20 of the coupling element 9 and then meets the curved reflecting surface 46, from which it is reflected in the direction of a lens 23 arranged at 90° in relation to the light beam.

This embodiment is advantageous because it is not necessarily useful to proceed to a metallization of the reflecting surface in order to assure a good reflection of the optical beam, as in the case of the embodiments described in FIGS. 2a, 3, and 4a.

According to another alternative, in order to minimize the reflection phenomena at the level of the inlet/outlet face 20 of the coupling element 9 and of the inlet/outlet face of the waveguides, it is advantageous to replace the air trapped in the interstice by a paste or a gel that has an optical refractive index close to those of the core of the waveguide and of the coupling element. However, if such a material has to fill the entire interstice, it is recommended to metallize the curved surface 46 in order to assure a good light reflection.

In the examples described in the preceding, the coupling element is positioned in the cavity created by the cut; it closes this cut and thus prevents foreign bodies from being able to contaminate the interstitial zone between the inlet/outlet faces of the embedded waveguides and the coupling element.

Described in FIGS. 5, 6 are the means of positioning the coupling element alternatively to the complementary centering profiles 16, 17 or serving to complement this system.

These means are constituted by metallized zones of the reference surface 11 of the circuit and metallizations produced on the coupling element in order to constitute metallic studs intended to solder the coupling element onto the reference surface 11 by means of solder beads.

In fact, it is possible by employing solder beads to position an electronic component with great precision by subjecting the beads to a remelting between the metallic studs.

This technique, known under the English name “ball grid array” (BGA), is used, for example, for soldering integrated circuits, containing connection studs on their lower surface, in the surface of a printed circuit furnished with connection tracks of these components.

Here, the reference surface 11 and the lower positioning surfaces 13 of the coupling element are provided respectively with mounting studs 30 for metallized centering balls on one side and with metallized studs 31 on the other side, between which the beads or balls of solder 32 are arranged, the latter permitting by remelting the alignment and the fixing of the coupling element in the cut.

By means of this principle, the coupling element is fixed in the cut during the remelting of the solder balls and the lenses 23, or the inlet/outlet faces of the coupling element 9 are positioned in alignment with the embedded waveguides.

Two variants are possible, in addition depending on the presence or absence of alignment profiles.

In the case where alignment profiles are absent, the coupling element, bearing the balls, is placed in the cavity and the remelting step is carried out, for example, in an infrared oven, which positions and solders the element by melting and then cooling of the balls.

The reference surface 11 and at least one of the lower positioning surfaces 13 of the coupling element being provided respectively with the metallized centering studs 30 and with the metallized studs 31, between which the balls of solder 32 are arranged, the balls then permitting, during their remelting, the alignment and the fixation of the coupling element in the cut 8. According to this principle, the balls of solder 32 then create the alignment of lenses 23 of the coupling element 9 with the embedded waveguide 6.

In the case where complementary centering profiles 16, 17 are present, the coupling element bearing the balls is positioned in the cavity supported on the balls and then, during the remelting of the balls, the element is positioned on the profile 16, the cooling of the balls soldering the coupling element in position.

According to this embodiment, the balls do not take part in the alignment of the inlet/outlet faces of the element with the waveguide or waveguides, but assure solely the fixation of the optical element 9 in its cavity.

The invention is not limited to the examples depicted and, in particular, several configurations of use of the coupling element are possible, it being possible for the latter, as depicted in FIG. 1, to consist of a receiving base for an optical plug 40 provided with fibers 2 or it being possible, in a configuration with several waveguides, such as described in FIGS. 2a, 3, 4a, and 4b, for it to consist of a multipath connector element, whereby the waveguides can be, as depicted, on top of one another or else in a single plane that is parallel to the upper plane of the printed circuit.

Moreover, it is possible by means of the device according to the invention to produce optical connections for several optical plugs on a circuit, such as a backplane card or for daughter cards provided with optical fibers in the end and waveguides, themselves embedded, these cards being received on the backplane.

The invention permits, by using a coupling element that can be simply produced by molding or micromolding, having possibly been subjected to a metallization step, the treatment of optical connections in the same manner as electrical connections, the optical connections being able to spread out on the surface of the circuit.

The example of application depicted in FIG. 7 particularly envisions the connection of optical paths of daughter cards C1, C2, C3, C4 to embedded waveguides of a backplane card. In order to do this, the backplane card comprises a plurality of optical couplers provided with coupling elements 9 according to the invention that receive optical plugs 40, the external optical paths 2 being subsequently connected at the level of daughter cards to internal paths via second couplers 46.

1. An optical coupling device between at least one waveguide embedded in a printed circuit, for conveying an optical beam (F), and an external waveguide, the circuit comprising, starting from an exterior surface of the circuit, at least one insulating first layer and at least one waveguide incorporating at least one core of embedded waveguide, the device comprising a coupling element positioned in a cut, hollowed out in the circuit and cutting the embedded waveguide, the coupling element including means for refocusing the optical beam between the embedded waveguide and the external waveguide and at least one lower positioning surface on a reference surface of the cut in relation to the axis of the embedded waveguide.

2. The optical coupling device according to claim 1, further characterized in that the cut comprises a first section of a first width at the level of the insulating layer up to said reference layer and a second section at the level of the internal layer incorporating the embedded waveguide, the second section being of reduced width in relation to the first section in such a manner as to produce the reference surface as a substratum of the external plane, the coupling element comprising an upper body provided with lower positioning surfaces supported on the reference surface and a lower body arranged in the second section opposite to segments of the waveguide situated on both sides of the cut.

3. The device according to claim 1, further characterized in that said reference surface is the external surface of the core of the embedded waveguide.

4. The device according to claim 1, further characterized in that said reference surface is the external surface of a cladding of the core of the embedded waveguide.

5. The coupling device according to claim 1, further characterized in that the coupling element is at least in part transparent and is provided with a first inlet/outlet face opposite to at least one inlet/outlet face of a segment of the waveguide and a second inlet/outlet face of the beam (F) exiting from the upper plane of the circuit, the beam transiting into the coupling element between the first and second faces.

6. The coupling device according to claim 1, further characterized in that the coupling element and the bottom of the cut comprise complementary centering profiles of the coupling element along an axis perpendicular to the surface of the circuit.

7. The coupling device according to claim 6, further characterized in that the centering profile borne by the bottom is a male profile provided with a generally conical form.

8. The coupling device according to claim 6, further characterized in that the complementary centering profile comprises an inclined reflecting surface arranged opposite to an inlet/outlet face of a segment of the core of the waveguide.

9. The coupling device according to claim 1, further characterized in that it comprises, in addition, a profile borne by the bottom of the cut, said profile comprising an inclined reflecting face arranged opposite an inlet/outlet face of a segment of the core of the waveguide.

10. The coupling device according to claim 5, further characterized in that the coupling element comprises, on a face opposite to its inlet/outlet face, an inclined reflecting surface, said face forming a face of reflection of the optical beam (F).

11. The coupling device according to claim 5, further characterized in that the coupling element comprises, on its inlet/outlet face an inclined surface of reflection and return of the optical beam.

12. The coupling device according to claim 5, further characterized in that the coupling element comprises at least one curved surface of reflection and return of the optical beam.

13. The coupling device according to claim 5, further characterized in that at least one of the inlet/outlet faces is provided with a coupling lens.

14. The coupling device according to of claim 1, further characterized in that the segments of the core of the waveguide are terminated at the level of the cut by inclined faces, reflecting the optical beam (F) in a direction at 90°, the upper body of the coupling element being provided with a first inlet/outlet face opposite to the reference surface and a second inlet/outlet face external to the circuit, the optical beam (F) transiting in the coupling element between the first and second inlet/outlet faces.

15. The coupling device according to claim 1, further characterized in that the reference surface and at least one of the lower positioning surfaces of the coupling element are provided respectively with mounting studs for metallized centering beads or balls and with metallized studs between which balls of solder are arranged, the latter permitting, by remelting, the alignment and fixation of the coupling element in the cut.

16. The coupling device according to claim 15, further characterized in that the balls of solder produce the alignment of lenses of the coupling element with the embedded waveguide.

17. The coupling device according to claim 1, further characterized in that the coupling element is made up of a receiving base for a terminal plug of optical fibers.
